(19) United States
(12) Patent Application Publication
(10) Pub. No.: US 2008/0010677 A1
(43) Pub. Date: Jan. 10, 2008

(54) Apparatus, method and computer program product providing improved sequence number handling in networks

(75) Inventors: Tsuyoshi Kashima, Yokohama (JP); Dan Forsberg, Helsinki (FI); Vinh Van Phan, Oulu (FI); Benoist Sebire, Tokyo (JP); Dajiang Zhang, Beijing (CN)

Correspondence Address: HARRINGTON & SMITH, PC, 4 RESEARCH DRIVE, SHELTON, CT, 06484-6212, US

(73) Assignee: Nokia Corporation

(21) Appl. No.: 11/821,748

(22) Filed: Jun. 25, 2007

Related U.S. Application Data
(60) Provisional application No. 60/816,653, filed on Jun. 26, 2006.

(51) Int. Cl. G06F 17/00; H04L 29/06

(52) U.S. Cl. 726/12; 726/14

(57) ABSTRACT

The exemplary embodiments of the invention provide apparatus, methods and computer program products that enable improved sequence number handling in networks, such as an evolved universal terrestrial radio access network (E-UTRAN), for example. In one non-limiting, exemplary embodiment, a method includes: generating a sequence number offset value; and transmitting a protected message having the generated sequence number offset value over a wireless communication link from a first device towards a second device, wherein the generated sequence number offset value is for use by the second device in generating a sequence number for a subsequent transmission. As non-limiting examples, the first device may be one of a mobile station or a base station, the second device may be one of a mobile station, a base station or a center node, and if one of the first device or the second device is a mobile station then the other of the first device and the second device is not a mobile station. As another non-limiting example, the first device and the second device may be components of an evolved universal terrestrial radio access network (E-UTRAN). As further non-limiting examples, the first device may be one of an E-UTRAN node B (eNB) or a user equipment (UE), the second device may be one of an eNB, a UE or a service gateway, and if one of the first device or the second device is a UE then the other of the first device and the second device is not a UE.

### CROSS-REFERENCE TO RELATED APPLICATIONS

This patent application claims priority under 35 U.S.C. § 119(e) from Provisional Patent Application No. 60/816,653, filed Jun. 26, 2006, the disclosure of which is incorporated by reference herein in its entirety.

### TECHNICAL FIELD

The exemplary embodiments of this invention relate generally to wireless communications systems, methods, computer program products and devices and, more specifically, relate to the use of sequence numbers (SNs) between mobile devices and network devices.

### BACKGROUND

The following abbreviations are herewith defined:

3GPP third generation partnership project

aGW access gateway

ARQ automatic repeat-request

AS access stratum

C-Plane control plane

C-RNTI cell radio network temporary identifier

eNB E-UTRAN node B, evolved node B

EPC evolved packet core

E-UTRA evolved universal terrestrial radio access

E-UTRAN evolved universal terrestrial radio access network

HO hand off (hand over)

LTE long term evolution of UTRAN

MAC medium access control

MD5 message digest 5

MM mobility management

MME mobility management entity

NAS non-access stratum

Node B base station

PDCP packet data convergence protocol

PDU protocol data unit

PHY physical layer

RB radio bearer

RLC radio link control

RRC radio resource control

RRM radio resource management

SAE system architecture evolution of UTRAN

SDU service data unit

S-GW serving gateway

SN sequence number

UE user equipment, such as a mobile station or mobile terminal

U-Plane user plane

UTRAN universal terrestrial radio access network

FIG. 1 provides an overview of the E-UTRAN architecture. The main units designated LN represent logical nodes, one each for an eNB 2 and an aGW 4. The architecture depicted in FIG. 1 also shows the functional entities of the C-Plane 6 (e.g., Inter Cell RRM) and the functional entities of the U-Plane 8 (e.g., RLC).

Referring to FIG. 1, the E-UTRAN system includes eNBs (e.g., eNB 2) that provide the E-UTRA U-Plane 8 (RLC/MAC/PHY) and C-Plane 6 (RRC) protocol terminations towards the UE. The eNBs interface to an aGW (e.g., aGW 4) where the PDCP function for the U-Plane is located via the S1 interface. Thus, the U-Plane for one UE spans two network nodes in E-UTRAN: one aGW and one eNB. Reference in this regard may be made to 3GPP TR 25.813, V7.0.0, “3rd Generation Partnership Project; Technical Specification Group Radio Access Network; Evolved Universal Terrestrial Radio Access (E-UTRA) and Evolved Universal Terrestrial Radio Access Network (E-UTRAN); Radio interface protocol aspects (Release 7),” June 2006.

To support the provision of services such as in-sequence delivery and ARQ, as two non-limiting examples, sequence numbers are typically transmitted with PDUs. More specifically, since in-sequence delivery is required for header compression and a unique initialization vector for ciphering between the PDCP peer entities in the aGW and UE, a sequence number is generated by the PDCP for transmission with PDCP PDUs (this is referred to as a PDCP_SN). Since ARQ is supported by the RLC peer entities in eNB and UE, another sequence number is required by the RLC for transmission with RLC PDUs (this is referred to as a RLC_SN). AS and NAS signaling security (ciphering and integrity protection) also requires a sequence number.

### SUMMARY

In an exemplary aspect of the invention, a method includes: generating a sequence number offset value; and transmitting a protected message having the generated sequence number offset value over a wireless communication link from a first device towards a second device, wherein the generated sequence number offset value is for use by the second device in generating a sequence number for a subsequent transmission.

In another exemplary aspect of the invention, a computer program product includes program instructions embodied on a tangible computer-readable medium. Execution of the program instructions results in operations including: generating a sequence number offset value; and transmitting a protected message having the generated sequence number offset value over a wireless communication link from a first device towards a second device, wherein the generated sequence number offset value is for use by the second device in generating a sequence number for a subsequent transmission.

In a further exemplary aspect, an electronic device includes: a data processor configured to generate a sequence number offset value; and a transmitter configured to transmit a protected message having the generated sequence number offset value over a wireless communication link from the electronic device towards another electronic device, wherein the generated sequence number offset value is for use by the other electronic device in generating a sequence number for a subsequent transmission.

In another exemplary aspect, an electronic device includes: means for generating a sequence number offset value; and means for transmitting a protected message having the generated sequence number offset value over a wireless communication link from the electronic device towards another electronic device, wherein the generated sequence number offset value is for use by the other electronic device in generating a sequence number for a subsequent transmission.

In a further exemplary aspect, an electronic device includes: a receiver configured to receive a protected message having a generated sequence number offset value over a wireless communication link from another electronic device; and a data processor configured to generate a sequence number based on the generated sequence number offset value and another sequence number.

In another exemplary aspect, a method includes: generating, by a first device, an offset value based on a first function and information common to a second device, wherein the offset value has a non-zero value; determining, by the first device, a second sequence number based on a first sequence number and the generated offset value; and one of transmitting or receiving a message including the determined second sequence number towards or from the second device.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 depicts the E-UTRAN architecture;

FIGS. 2-7 present various exemplary embodiments of this invention for implementing the use of a SN OFFSET value;

FIG. 8 illustrates an exemplary message flow diagram depicting a reference HO signaling scheme that can be employed when implementing various ones of the exemplary embodiments of this invention;

FIG. 9 a simplified block diagram of various electronic devices that are suitable for use in practicing the exemplary embodiments of this invention;

FIGS. 10 and 11 illustrate the E-UTRAN architecture as per RP-070494;

FIG. 12 depicts a flowchart illustrating one non-limiting example of a method for practicing the exemplary embodiments of this invention; and

FIG. 13 depicts a flowchart illustrating another non-limiting example of a method for practicing the exemplary embodiments of this invention.

### DETAILED DESCRIPTION

At least two problems have been perceived with the definition and model of the E-UTRAN system.

The first problem relates to the fact that the PDCP_SN is continuous, even during a HO. That is, if the PDCP_SN is sent over the air without encryption, the corresponding UE could be tracked by a passive attacker from one cell to another. The same could occur with AS and NAS signaling messages, depending on how they are protected and if their SN is sent in plain text over the air (alternatives exists such as transferring the NAS messages within ciphered AS messages).

The second problem relates to that fact that sending both the PDCP_SN and RLC_SN over the air is redundant, in that both are incremented at the same time.

One possible approach would be to encrypt the SN. However, if the SN is necessary for decryption, the same encryption cannot be used. Thus, another encryption scheme would need to be applied, resulting in increased complexity.

Further, if the SN were encrypted and decrypted with every PDU, the overhead increases in terms of both computation and the size of a PDU. In addition, the SN cannot be used as part of the initialization vector for the ciphering function.

The exemplary embodiments of this invention address these and other problems.

While the exemplary embodiments will be described below in the context of the E-UTRAN (UTRAN-LTE) system, it should be appreciated that the exemplary embodiments of this invention are not limited for use with only this one particular type of wireless communication system, and that they may be used to advantage in other wireless communication systems. Thus, the exemplary embodiments could also be described using more general, non-E-UTRAN-specific terminology, such as by referring to center nodes, base stations and mobile terminals, as opposed to aGWs, eNBs and UEs, for example.

Furthermore, while the below-described exemplary embodiments utilize an E-UTRAN system as described by 3GPP TR 25.813 V7.0.0, it should be appreciated that the exemplary embodiments of this invention are not limited for use with only this one particular type of E-UTRAN system, and that they may be used to advantage in other types of E-UTRAN systems. As a non-limiting example, the exemplary embodiments of the invention may also be utilized in conjunction with an E-UTRAN system as described by 3GPP TS 36.300, V8.0.0, “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 8),” March 2007. As a further non-limiting example, the exemplary embodiment of the invention may also be utilized in conjunction with an E-UTRAN system as further described by RP-070494, Change Request, 36.300 CR 0002, rev. 1, 3GPP TSG-RAN Meeting #36, Busan, Korea, 29 May-1 Jun. 2007.

U-Plane:

In accordance with the exemplary embodiments of this invention an offset is introduced when mapping the PDCP_SN generated at the PDCP onto the RLC_SN used at the RLC, for example, for ARQ and reordering. At HO, and when necessary (for example, during a state transition from IDLE to CONNECTED, or for any other reason), the offset is changed so that the tracking of a UE based on the SN is not possible.

One suitable relationship between the RLC_SN and the PDCP_SN is:
RLC_SN=PDCP_SN+OFFSET (1)

On the transmitter side, the RLC_SN may be generated from the PDCP_SN, and on the receiver side the PDCP_SN can be recovered from the RLC_SN based on equation (1). By the use of this technique, it is not necessary to send both the PDCP_SN and RLC_SN over the air, which reduces or eliminates the redundancy noted above.

In addition, the value of OFFSET may be changed at every HO so that attackers cannot regenerate it when both the UE and the target eNB have the same new OFFSET. This can prevent attackers from tracking a UE during HO by intercepting the RLC_SN. In addition, the state transition from IDLE to ACTIVE may also trigger the update of the value of the OFFSET parameter. This can prevent an attacker from tracking the UE even in the situation where the UE enters the IDLE state for some period before transitioning back to the ACTIVE state.

If desired, the value of the OFFSET parameters may be changed more or less frequently.

In another exemplary embodiment, without sending the PDCP_SN directly, an OFFSET value can be used make the SN transmitted over the air discontinuous, for example, at every handover. For example:
PDCP_SN over the air=PDCP_SN in the entity counter+OFFSET (2)

In equation (2), the expression “PDCP_SN in the entity counter” may be interpreted to mean the originated PDCP_SN that is set, before adding any offset, to count in-sequence PDCP messages transmitted on the corresponding signaling bearer or logical channel over the air interface.

C-Plane:

The second problem discussed above can also be applied to the C-Plane. Two cases of interest are considered.

1. An RRC-Generated Signal or a NAS Signal that is Encrypted by the RRC

For ciphering purposes, RRC peer entities need to have a common sequence number (this is referred to as a RRC_SN). Without sending the SN directly, the RRC can use the OFFSET value to make the SN transmitted over the air discontinuous, for example, at every handover. For example:
RRC_SN over the air=RRC_SN in the entity counter+OFFSET (3)

In equation (3), the expression “RRC_SN in the entity counter” may be interpreted to mean the originated RRC_SN that is set, before adding any offset, to count in-sequence RRC messages transmitted on the corresponding signaling bearer or logical channel over the air interface.

Note that for the ciphering function, the sequence number should be unique for one key set and, thus, the same sequence number should not be used twice with the same keys. If the OFFSET parameter is not used, then the sequence number space could be consumed much more rapidly or it could become more difficult to determine which sequence numbers have already been used with the key set. The use of the OFFSET value facilitates the recovery of the RRC SN, and keeping the RRC_SN continuous between HOs.

2. A NAS Signal that is not Encrypted by the RRC

If there are NAS signals that are not encrypted by the RRC, the RRC may change the NAS signaling sequence number by using the OFFSET parameter in a similar manner.

Note that equations (1), (2) and (3) are expressed as schematic formula. In practice, and due to the fact that the field of the RLC_SN, PDCP_SN and other SN have predetermined sizes (such as 16 bits, 32 bits or 48 bits), these equations are preferably implemented so that the size limitation is satisfied.

The exemplary embodiments of this invention thus pertain at least in part to SN redundancy deletion/mitigation, the use of the OFFSET parameter, and the updating of the OFFSET parameter. The mapping between the RLC_SN and PDCP_SN may be in accordance with equation (1).

The following additional description of the exemplary embodiments of this invention is presented in the 3GPP LTE/SAE context, but is not limited for use with only the 3GPP LTE/SAE. In the following description, and merely for convenience of description, the source eNB is designated as 10, the target eNB is designated as 20, the UE is designated as 30, and the aGW is designated as 40.

Update of OFFSET in the UE 30 and the eNBs

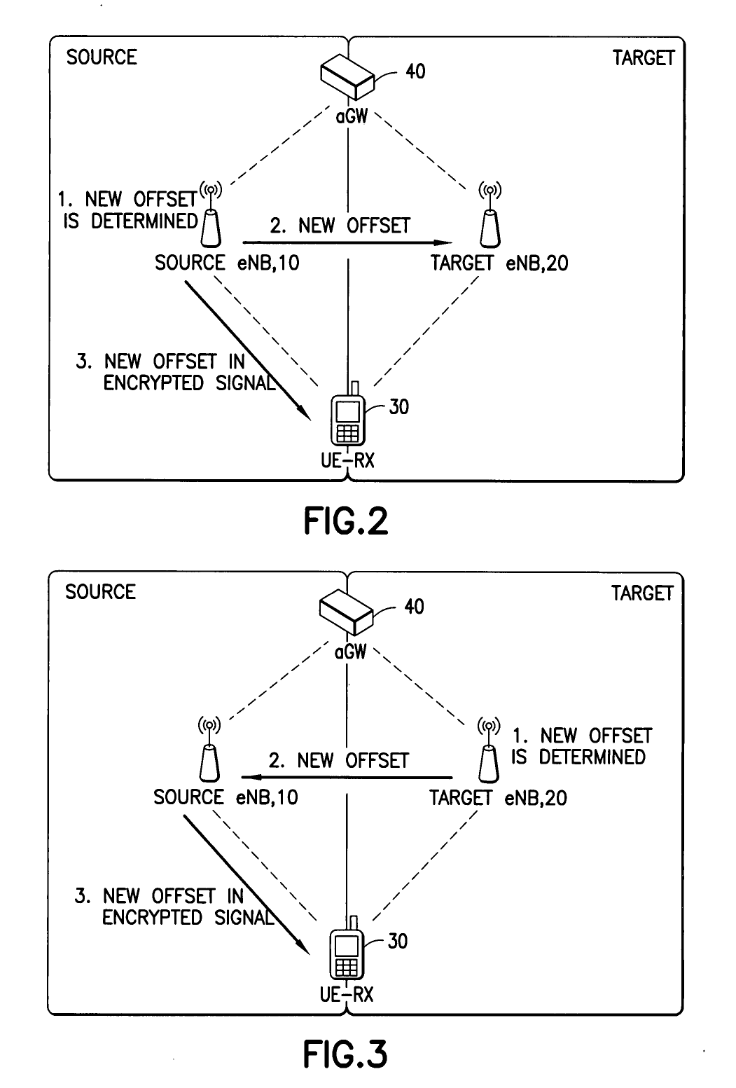

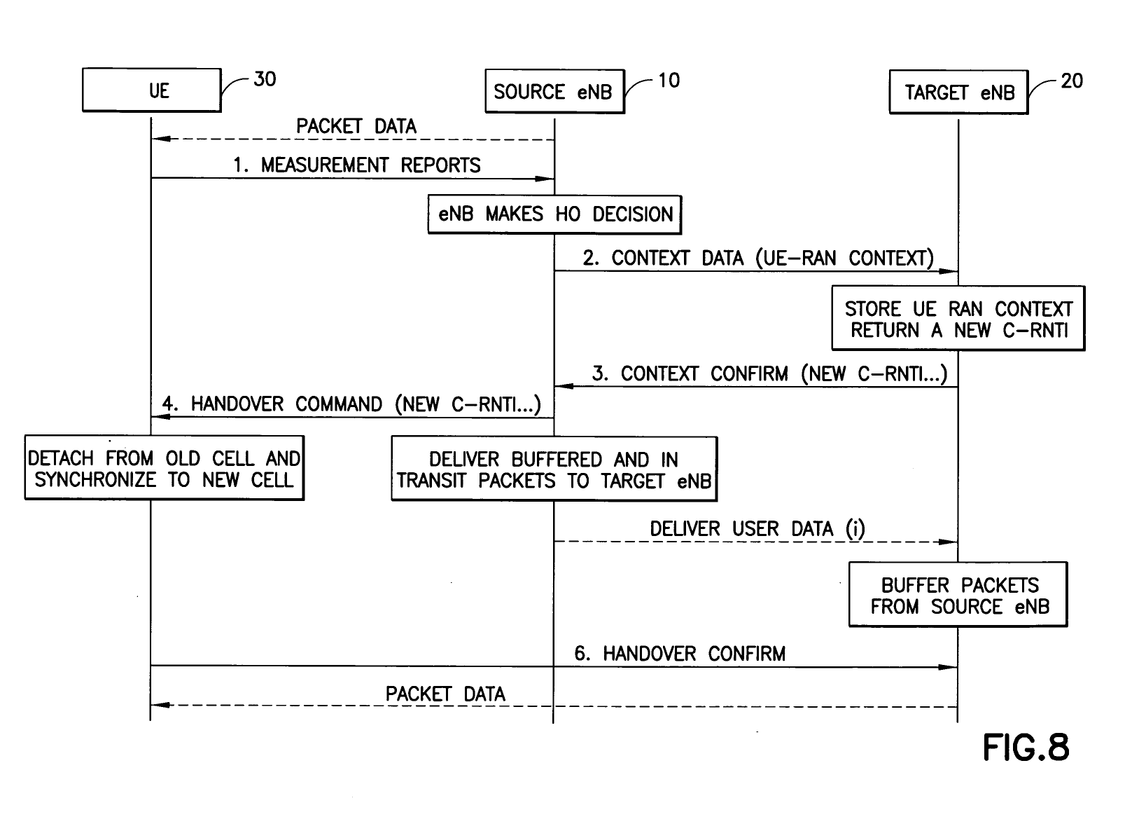

There are a number of implementation alternatives described below in reference to FIGS. 2 through 7, each of which may be considered to represent an exemplary embodiment of this invention. A reference handover signaling scheme, referred to in several of the exemplary embodiments, is shown in FIG. 8.

Alternative (OFFSET) 1 (FIG. 2):

The source eNB 10 determines a new OFFSET to be used after the HO. For example, the new OFFSET value can be randomly generated. The source eNB 10 sends the OFFSET value to the target eNB 20 and to the UE 30. At a minimum, the message to the target eNB 20 is encrypted. For example, in the reference handover signaling scheme of FIG. 8, a new OFFSET can be sent to the target eNB 20 in a “Context Data” message, and sent to the UE 30 in a “Handover Command” message. In the “Handover Command” message, a new C-RNTI and OFFSET value are sent in the same encrypted message.

Alternative (OFFSET) 2 (FIG. 3):

The target eNB 20 determines a new OFFSET to be used after the HO. For example, the new OFFSET value can be randomly generated. The target eNB 20 sends the OFFSET value to the source eNB 10, and the source eNB 10 sends the OFFSET value to the UE. At a minimum, the message to the source eNB 10 is encrypted. For example, in the reference handover signaling scheme of FIG. 8, the new OFFSET can be sent to the source eNB 10 in a “Context Confirm” message (message 3 of FIG. 8), and then sent to the UE 30 in a “Handover Command” message (message 4 of FIG. 8) together with a new C-RNTI and other information. The source eNB 10 can send the new C-RNTI and OFFSET to the UE 30 in the same encrypted message, the “Handover Command”.

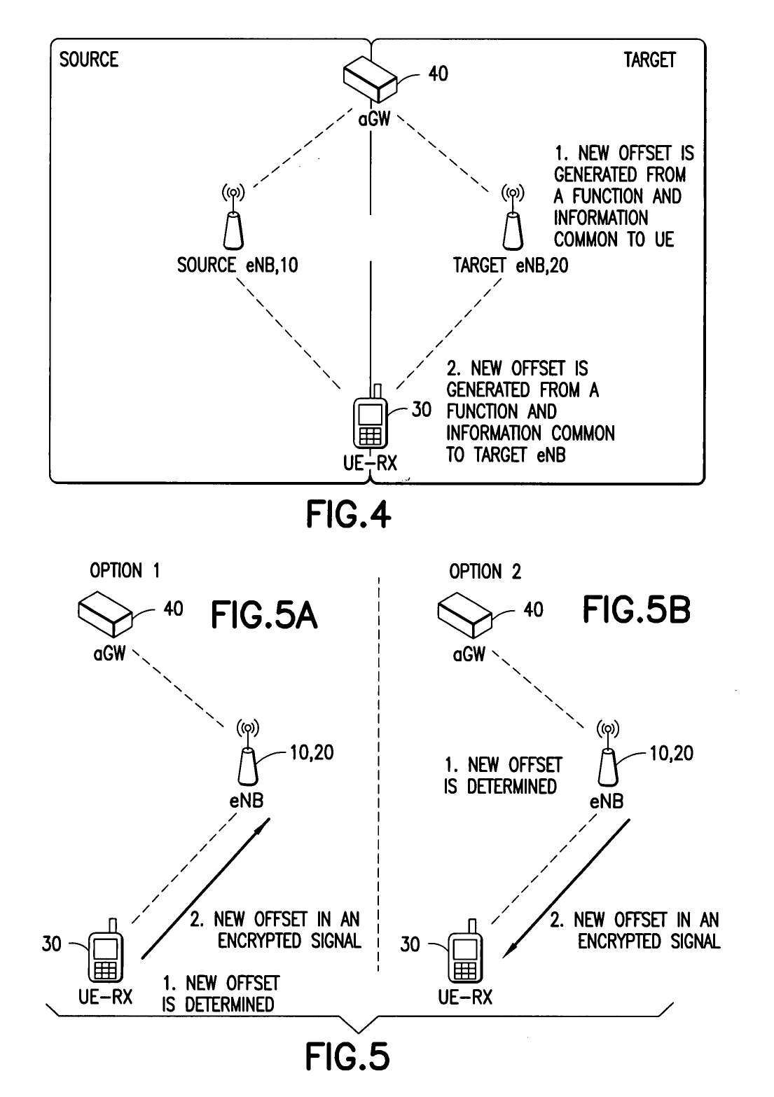

Alternative (OFFSET) 3 (FIG. 4):

Without a need to send a new OFFSET to the other party, both the UE 30 and the target eNB 20 calculate the OFFSET value based on a specified function using input parameters explicitly known to the two end points. A non-limiting example of a function that is suitable for this purpose is MD5 (eNB-identity, integrity protection key, constant bit string, OFFSET-number), and from the function result the desired number of least meaningful bits (e.g., 8 bits or 16 bits) are extracted and used as the OFFSET value.

It can be noted in this regard that as the proper plain text SN is needed to decrypt the encrypted message (used as the initialization vector), it is not desirable to send the OFFSET value in an encrypted message after the handover as in this case the receiver would not be able to determine the correct SN.

Alternative (OFFSET) 4 (FIGS. 5A, 5B):

This embodiment may be viewed as an option that would generally not be suitable for use in the HO case. If an OFFSET update procedure is necessary or desired, irrespective of HO, then this approach may be used. The target eNB 20 (FIG. 5B), or the UE 30 (FIG. 5A), generates a new OFFSET value (e.g., randomly) and sends it to the peer entity via an encrypted control signal. In an exemplary implementation the OFFSET value can be included in a HO control signal. For example, in the reference handover signaling scheme of FIG. 8, it can be included in the “Handover Confirm” message (message 6).

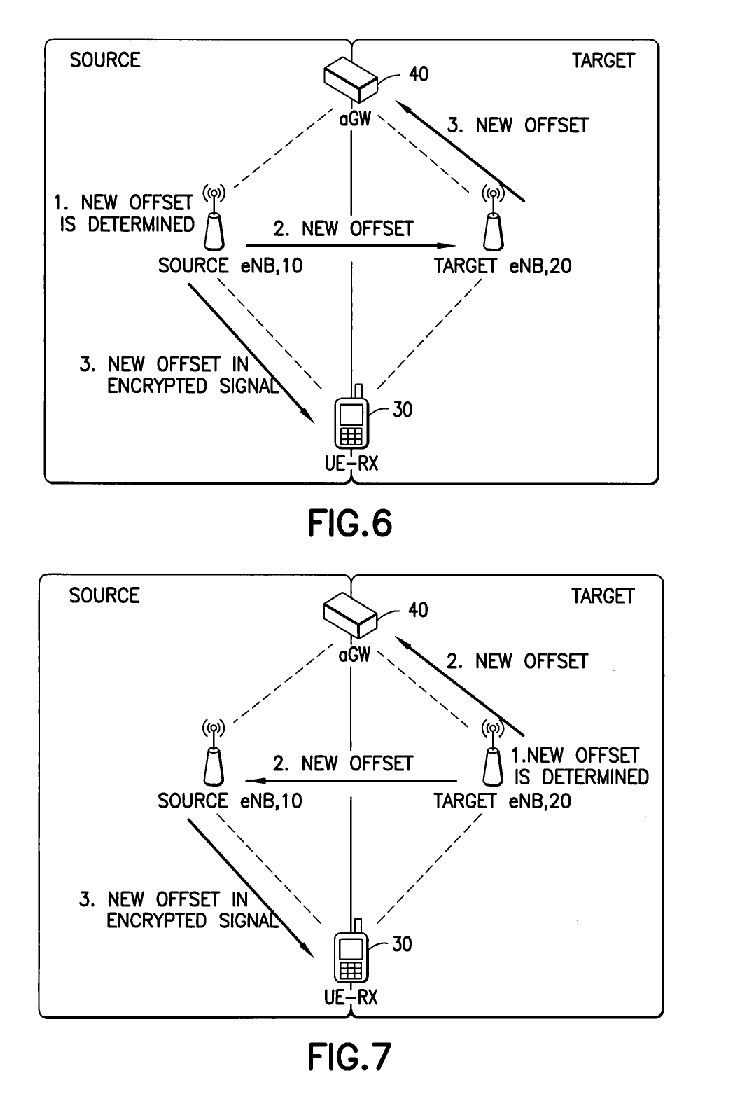

Alternative (OFFSET) 5 (FIGS. 6, 7):

The new OFFSET value can be determined in the source eNB 10 (FIG. 6) or in the target eNB 20 (FIG. 7), and the new OFFSET value is provided to the aGW 40. The aGW 40 changes the U-Plane and/or NAS signaling sequence numbers respectively using the provided OFFSET value. An advantage of the use of this embodiment is that the eNB does not have to change the PDCP sequence number for all packets, but possibly only for those U-Plane packets arriving from the source eNB 10 (since they would contain the old SN). The use of this exemplary embodiment may be beneficial with a path switch message sent from the target eNB 20 to the aGW 40. Note, however, that this exemplary embodiment assumes the support and participation of the aGW 40, while the embodiments of FIGS. 2-5 do not.

Note further with regard to this exemplary embodiment that the new OFFSET value could be determined in the UE 30 as in the embodiment of FIG. 5A, and relayed to the aGW 40 by the eNB.

There are a number of advantages that can be realized by the use of the exemplary embodiments of this invention. For example, one may realize a reduction in the SN overhead, as the redundancy of the PDCP_SN and RLC_SN over the air can be eliminated as only RLC_SN is transmitted over the air. Further by example, one can avoid UE 30 tracking by a possibly malicious party based on SN, as the RLC_SN sent over the air is not the same at every handover. As a further example of the advantages that may be realized, the OFFSET value update can be performed without any additional separate signaling being required. Further, and especially in the case of the alternative (OFFSET) 3 (FIG. 4), no explicit control signaling exchange is needed. For example, the changing of the OFFSET value may be based on a timer expiring or some other event, such as each time the SN value overflows.

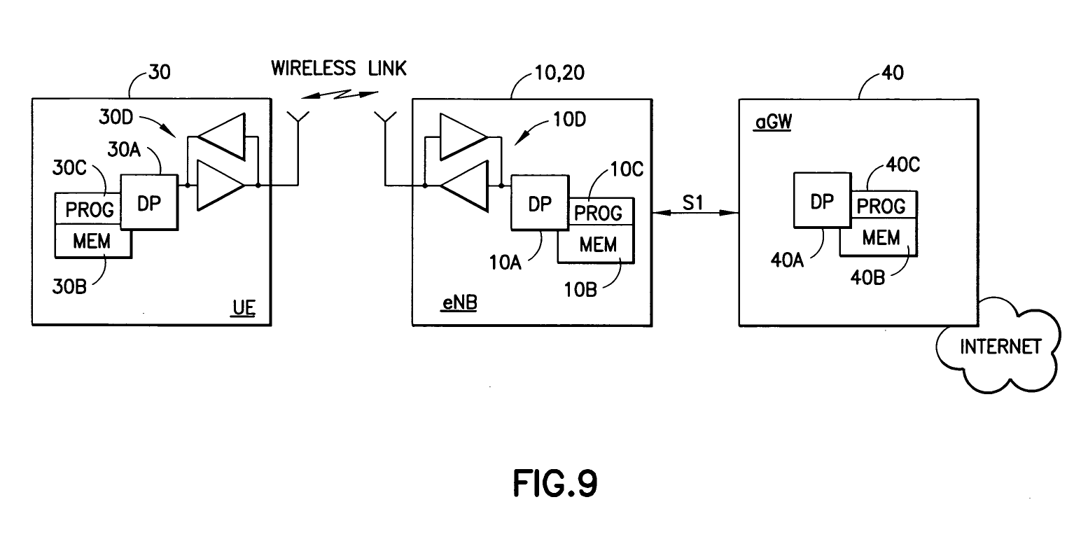

Reference is now made to FIG. 9 for illustrating a simplified block diagram of various electronic devices that are suitable for use in practicing the exemplary embodiments of this invention as described above. In FIG. 9, a wireless network, in this non-limiting example an E-UTRAN network, is adapted for communication with the UE 30 via Node Bs (eNBs) 10, 20 (depending on whether the eNB is the source eNB or the target eNB). The network includes the aGW 40 providing Internet connectivity. The UE 30 includes a data processor (DP) 30A, a memory (MEM) 30B that stores a program (PROG) 30C, and a suitable radio frequency (RF) transceiver 30D for bidirectional wireless communications with the eNB 10, 20, which also includes a DP 10A, a MEM 10B that stores a PROG 10C, and a suitable RF transceiver 10D. The eNB 10, 20 is coupled via a data path providing the S1 interface to the aGW 40 that also includes a DP 40A and a MEM 40B storing an associated PROG 40C. Various ones of the PROGs 10C, 30C and 40C are assumed to include program instructions that, when executed by the associated DP, enable the electronic device to operate in accordance with the exemplary embodiments of this invention, for example, as described above in reference to FIGS. 2-8.

In general, the various embodiments of the UE 30 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the associated DPs, or by hardware, or by a combination of software and hardware. As a non-limiting example, the exemplary embodiments of this invention may be implemented using one or more integrated circuits.

The MEMs 10B, 30B and 40B may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 10A, 30A and 40A may be of any type suitable to the local technical environment, and may include one or more of general purpose computers, special purpose computers, microprocessors, digital signal processors (DSPs) and processors based on a multi-core processor architecture, as non-limiting examples.

As previously noted, the exemplary embodiments of the invention may be utilized in accordance with an E-UTRAN system described by RP-070494 which is a change request for 3GPP TS 36.300 V8.0.0. Such a system will be considered briefly.

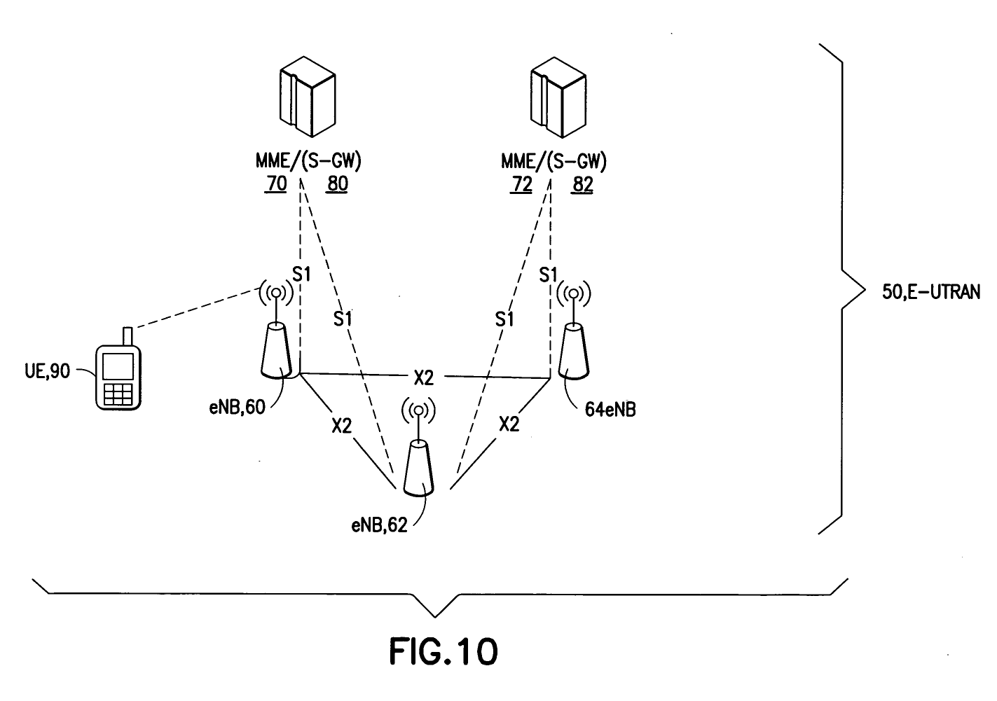

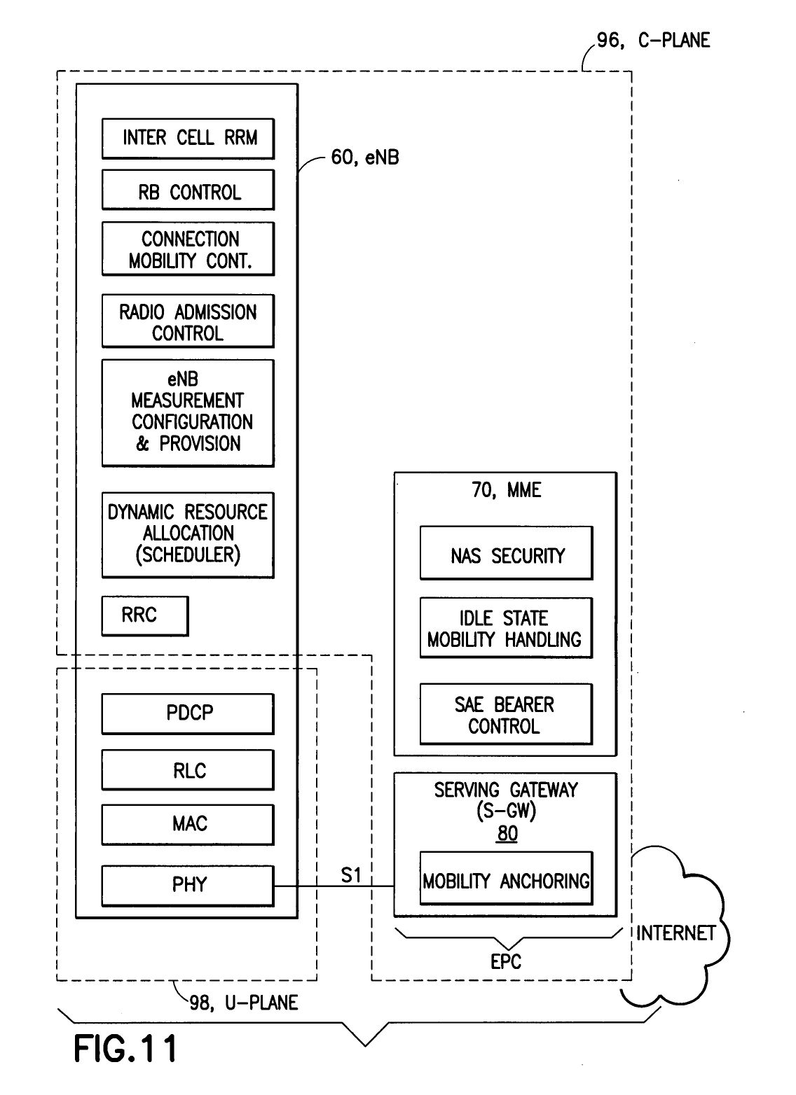

FIGS. 10 and 11 provide an overview of the E-UTRAN architecture per RP-070494. Note that FIG. 10 corresponds to FIG. 4 of RP-070494 and FIG. 11 corresponds to FIG. 4.1 of RP-070494.

The units shown in FIG. 11 represent logical nodes for the eNB 60, the MME 70 and the S-GW 80. The architecture depicted in FIG. 11 also shows the functional entities of the C-Plane 96 (e.g., Inter Cell RRM) and the function entities of the U-Plane 98 (e.g., RLC).

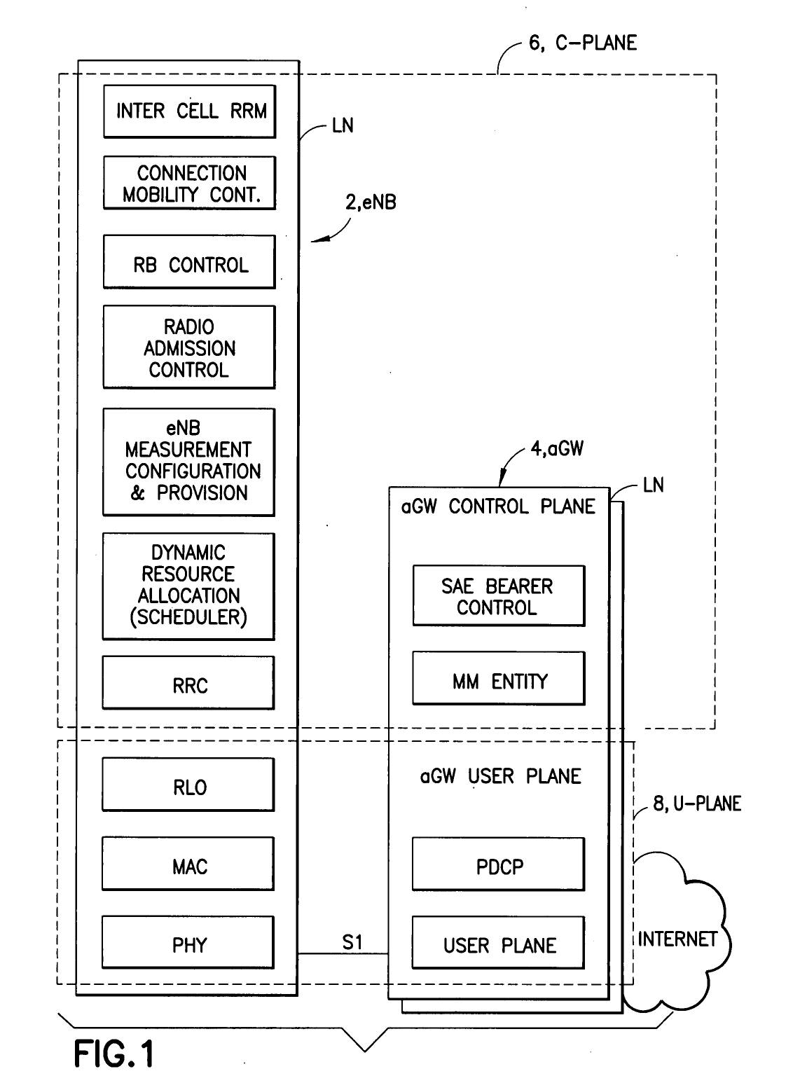

The E-UTRAN 50 includes at least one eNB 60 that provides the E-UTRA U-Plane (PDCP/RLC/MAC/PHY) and C-Plane (RRC) protocol terminations towards the UE 90. The eNBs 60, 62, 64 of the E-UTRAN 50 are interconnected with each other via the X2 interface. The eNBs 60, 62, 64 are also connected to the EPC via the S1 interface, more specifically to the MMEs 70, 72 via the S1-MME and to the S-GWs 80, 82 via the S1-U. The S1 interface supports a many-to-many relation between MMEs/S-GWs and eNBs. Note that in the E-UTRAN architecture depicted in FIGS. 10 and 11, the PDCP layer is located in the eNB 60 instead of in an aGW 4, as shown in FIG. 1. Furthermore, while it may not be apparent from the architecture shown in FIG. 11, the S-GW 80 hosts the termination of U-Plane packets for paging purposes, as described by Section 4.1 of RP-070494.

In one non-limiting, exemplary embodiment, the UE 90 generates a sequence number offset value and transmits a protected message comprising the generated sequence number offset value to the eNB 60, wherein the generated sequence number offset value is for use by the eNB 60 in generating a sequence number for a subsequent transmission.

In another non-limiting, exemplary embodiment, the eNB 60 generates a sequence number offset value and transmits a protected message comprising the generated sequence number offset value to one of the eNB 62, the eNB 64, the UE 90, the MME 70 or the S-GW 80, wherein the generated sequence number offset value is for use by the other device in generating a sequence number for a subsequent transmission.

Note that in other exemplary embodiments, the E-UTRAN 50 may be considered to include the MMEs 70, 72 and the S-GWs 80, 82.

Based on the foregoing it should be apparent that the exemplary embodiments of this invention provide methods, apparatus, devices and computer program product(s) to modify sequence numbers of radio blocks sent over the air between a mobile station and a base station, and between base stations, by determining an offset value that is used to modify the value of the sequence numbers. The offset value is sent in a protected form over the air, such as by being sent in an encrypted message during, by example, a mobile station handover procedure.

In an exemplary embodiment a relationship between RLC_SN and PDCP_SN is given by the expression:
RLC_SN=PDCP_SN+OFFSET (4)

where the RLC_SN is generated from the PDCP_SN at a transmitter and is recovered from the RLC_SN at a receiver, thereby eliminating a need to send both the PDCP_SN and the RLC_SN over the air.

In an exemplary embodiment a need for RRC peer entities to operate with a common sequence number (RRC_SN) is satisfied, without sending the SN value itself directly over the air, by using the offset value to cause the SN sent over the air to be discontinuous between handovers as:
RRC_SN over the air=RRC_SN in an entity counter+OFFSET (5)

The value of the offset may be determined in the mobile station and communicated to the base station, or it may be determined in the base station and communicated to the mobile station, or it may be determined in both the mobile station and in the base station using a predetermined function having input parameters known to both the mobile station and the base station. The offset value may also be sent to a network node, such as the aGW, for use thereby in modifying sequence numbers of at least inbound radio blocks directed to the mobile station. The offset value may be determined using, for example, any procedure that yields a random or pseudo-random number as a result.

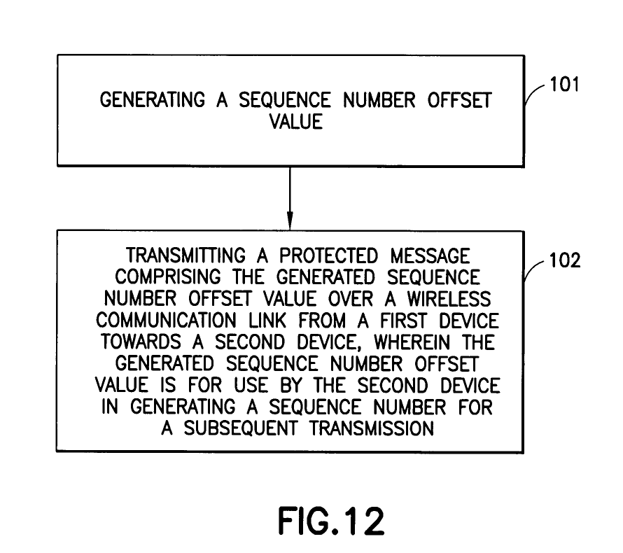

In one non-limiting, exemplary embodiment, and as shown in FIG. 12, a method includes: generating a sequence number offset value (box 101); and transmitting a protected message comprising the generated sequence number offset value over a wireless communication link from a first device towards a second device, wherein the generated sequence number offset value is for use by the second device in generating a sequence number for a subsequent transmission (box 102).

In other exemplary embodiments, the sequence number offset value comprises a randomly generated value. In further exemplary embodiments, the protected message comprises an encrypted message comprising at least the generated sequence number offset value. In other exemplary embodiments, generating the sequence number offset value comprises generating the sequence number offset value in response to at least one condition being met. In further exemplary embodiments, the at least one condition comprises at least one of a hand over taking place, a state transition taking place, a timer expiring and a sequence number value overflowing. In other exemplary embodiments, the protected message comprises one of a context data message, a context confirm message, a handover command message, a handover confirm message or a path switch message.

In further exemplary embodiments, the method further comprises: receiving the protected message comprising the generated sequence number offset value; and generating the sequence number based on the generated sequence number offset value and another sequence number. In other exemplary embodiments, the sequence number is a function of the other sequence number and the sequence number offset value, and the function comprises at least one of adding the sequence number and the sequence number offset value, subtracting the sequence number offset value from the sequence number, subtracting the sequence number from the sequence number offset value, multiplying the sequence number by the sequence number offset value, dividing the sequence number by the sequence number offset value and dividing the sequence number offset value by the sequence number.

In further exemplary embodiments, the sequence number comprises a packet data convergence protocol sequence number and the other sequence number comprises a radio link control sequence number. In other exemplary embodiments, the sequence number comprises a first radio resource control sequence number and the other sequence number comprises a second radio resource control sequence number. In further exemplary embodiments, the sequence number comprises a first radio resource control sequence number and the other sequence number comprises a second radio resource control sequence number. In other exemplary embodiments, the sequence number comprises a first packet data convergence protocol sequence number and the other sequence number comprises a second packet data convergence protocol sequence number.

In other exemplary embodiments, the first device comprises one of a mobile station or a base station, the second device comprises one of a mobile station, a base station or a center node, and if one of the first device or the second device comprises a mobile station then the other of the first device and the second device does not comprise a mobile station.

A center node is herein considered to be another network component to which a base station connects and communicates. As a non-limiting example, in an E-UTRAN, an access gateway (aGW) or a serving gateway (S-GW) may be considered a center node since the base station (E-UTRAN node B or eNB) communicates with the aGW or S-GW.

In further exemplary embodiments, the first device and the second device comprise components of a wireless network. In other exemplary embodiments, the wireless network comprises an evolved universal terrestrial radio access network (E-UTRAN). In further exemplary embodiments, the first device comprises one of an E-UTRAN node B (eNB) or a user equipment (UE), the second device comprises one of an eNB, a UE or an access gateway, and if one of the first device or the second device comprises a UE then the other of the first device and the second device does not comprise a UE.

In another non-limiting, exemplary embodiment, an electronic device comprises: a data processor configured to generate a sequence number offset value; and a transmitter configured to transmit a protected message comprising the generated sequence number offset value over a wireless communication link from the electronic device towards another electronic device, wherein the generated sequence number offset value is for use by the other electronic device in generating a sequence number for a subsequent transmission.

In another non-limiting exemplary embodiment, an electronic device comprises: means for generating a sequence number offset value; and means for transmitting a protected message comprising the generated sequence number offset value over a wireless communication link from the electronic device towards another electronic device, wherein the generated sequence number offset value is for use by the other electronic device in generating a sequence number for a subsequent transmission.

In other exemplary embodiments, the means for generating comprises a data processor and the means for transmitting comprises a transmitter. In further exemplary embodiments, the electronic device comprises one of a base station, a mobile station or a center node and the other electronic device comprises one of a base station, a mobile station or a center node.

In a further exemplary embodiment, an electronic device comprises: a receiver configured to receive a protected message comprising a generated sequence number offset value over a wireless communication link from another electronic device; and a data processor configured to generate a sequence number based on the generated sequence number offset value and another sequence number.

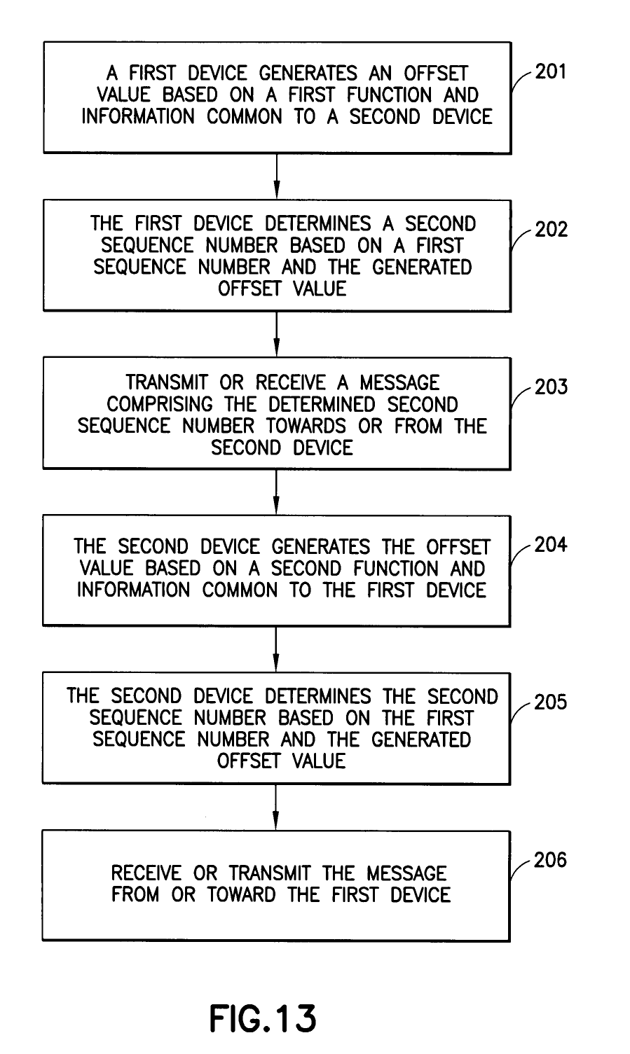

In another exemplary embodiment, and as shown in FIG. 13, a method comprises: generating, by a first device, an offset value based on a first function and information common to a second device, wherein the offset value has a non-zero value (box 201); determining, by the first device, a second sequence number based on a first sequence number and the generated offset value (box 202); and one of transmitting or receiving a message comprising the determined second sequence number towards or from the second device (box 203).

In other exemplary embodiments, the method further comprises: generating, by the second device, the offset value based on a second function and information common to the first device, wherein the offset value has a non-zero value (box 204); determining, by the second device, the second sequence number based on the first sequence number and the generated offset value (box 205); and one of receiving or transmitting the message from or towards the first device (box 206). In further exemplary embodiments, the first device and the second device comprise components of an evolved universal terrestrial radio access network (E-UTRAN), the first device comprises one of an E-UTRAN node B (eNB) or a user equipment (UE), the second device comprises one of an eNB, a UE or an access gateway, and if one of the first device or the second device comprises a UE then the other of the first device and the second device does not comprise a UE.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like), may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. For example, the determined OFFSET could be applied to the SN by other than an addition procedure, such by subtraction, or multiplication, or division, or through the use of some suitable hashing function, as several non-limiting examples. However, all such and similar modifications of the teachings of this invention will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
generating a sequence number offset value; and
transmitting a protected message comprising the generated sequence number offset value over a wireless communication link from a first device towards a second device, wherein the generated sequence number offset value is for use by the second device in generating a sequence number for a subsequent transmission.

2. The method of claim 1, wherein the sequence number offset value comprises a randomly generated value.

3. The method of claim 1, wherein the protected message comprises an encrypted message comprising at least the generated sequence number offset value.

4. The method of claim 1, wherein generating the sequence number offset value comprises generating the sequence number offset value in response to at least one condition being met.

5. The method of claim 4, wherein the at least one condition comprises at least one of a hand over taking place, a state transition taking place, a timer expiring and a sequence number value overflowing.

6. The method of claim 1, wherein the protected message comprises one of a context data message, a context confirm message, a handover command message, a handover confirm message or a path switch message.

7. The method of claim 1, further comprising:
receiving the protected message comprising the generated sequence number offset value; and
generating the sequence number based on the generated sequence number offset value and another sequence number.

8. The method of claim 7, wherein the sequence number is a function of the other sequence number and the sequence number offset value, wherein the function comprises at least one of adding the sequence number and the sequence number offset value, subtracting the sequence number offset value from the sequence number, subtracting the sequence number from the sequence number offset value, multiplying the sequence number by the sequence number offset value, dividing the sequence number by the sequence number offset value and dividing the sequence number offset value by the sequence number.

9. The method of claim 7, wherein the sequence number comprises a packet data convergence protocol sequence number and the other sequence number comprises a radio link control sequence number.

10. The method of claim 7, wherein the sequence number comprises a first radio resource control sequence number and the other sequence number comprises a second radio resource control sequence number.

11. The method of claim 7, wherein the sequence number comprises a first radio resource control sequence number and the other sequence number comprises a second radio resource control sequence number.

12. The method of claim 7, wherein the sequence number comprises a first packet data convergence protocol sequence number and the other sequence number comprises a second packet data convergence protocol sequence number.

13. The method of claim 1, wherein the first device comprises one of a mobile station or a base station, wherein the second device comprises one of a mobile station, a base station or a center node, wherein if one of the first device or the second device comprises a mobile station then the other of the first device and the second device does not comprise a mobile station.

14. The method of claim 1, wherein the first device and the second device comprise components of a wireless network.

15. The method of claim 14, wherein the wireless network comprises an evolved universal terrestrial radio access network (E-UTRAN).

16. The method of claim 15, wherein the first device comprises one of an E-UTRAN node B (eNB) or a user equipment (UE), wherein the second device comprises one of an eNB, a UE, a serving gateway or an access gateway, wherein if one of the first device or the second device comprises a UE then the other of the first device and the second device does not comprise a UE.

17. A computer program product comprising program instructions embodied on a tangible computer-readable medium, execution of the program instructions resulting in operations comprising:
generating a sequence number offset value; and
transmitting a protected message comprising the generated sequence number offset value over a wireless communication link from a first device towards a second device, wherein the generated sequence number offset value is for use by the second device in generating a sequence number for a subsequent transmission.

18. The computer program product of claim 17, wherein generating the sequence number offset value comprises generating the sequence number offset value in response to at least one condition being met.

19. The computer program product of claim 17, wherein execution of the program instructions resulting in operations comprising:
receiving the protected message comprising the generated sequence number offset value; and
generating the sequence number based on the generated sequence number offset value and another sequence number.

20. The computer program product of claim 19, wherein the sequence number is a function of the other sequence number and the sequence number offset value, wherein the function comprises at least one of adding the sequence number and the sequence number offset value, subtracting the sequence number offset value from the sequence number, subtracting the sequence number from the sequence number offset value, multiplying the sequence number by the sequence number offset value, dividing the sequence number by the sequence number offset value and dividing the sequence number offset value by the sequence number.

21. The computer program product of claim 17, wherein the first device comprises one of a mobile station or a base station, wherein the second device comprises one of a mobile station, a base station or a center node, wherein if one of the first device or the second device comprises a mobile station then the other of the first device and the second device does not comprise a mobile station.

22. The computer program product of claim 17, wherein the first device and the second device comprise components of an evolved universal terrestrial radio access network (E-UTRAN), wherein the first device comprises one of an E-UTRAN node B (eNB) or a user equipment (UE), wherein the second device comprises one of an eNB, a UE, a serving gateway or an access gateway, wherein if one of the first device or the second device comprises a UE then the other of the first device and the second device does not comprise a UE.

23. An electronic device comprising:
a data processor configured to generate a sequence number offset value; and
a transmitter configured to transmit a protected message comprising the generated sequence number offset value over a wireless communication link from the electronic device towards another electronic device, wherein the generated sequence number offset value is for use by the other electronic device in generating a sequence number for a subsequent transmission.

24. The electronic device of claim 23, wherein the data processor generates the sequence number offset value in response to a condition being met.

25. The electronic device of claim 23, wherein the electronic device comprises one of a base station or a mobile station, wherein the other electronic device comprises one of a base station, a mobile station or a center node, wherein if one of the electronic device or the other electronic device comprises a mobile station then the other of the electronic device and the other electronic device does not comprise a mobile station.

26. The electronic device of claim 23, wherein the electronic device and the other electronic device comprise components of an evolved universal terrestrial radio access network (E-UTRAN).

27. The electronic device of claim 26, wherein the electronic device comprises one of an E-UTRAN node B (eNB) or a user equipment (UE), wherein the other electronic device comprises one of an eNB, a UE, a serving gateway or an access gateway, wherein if one of the electronic device or the other electronic device comprises a UE then the other of the electronic device and the other electronic device does not comprise a UE.

28. An electronic device comprising:
means for generating a sequence number offset value; and
means for transmitting a protected message comprising the generated sequence number offset value over a wireless communication link from the electronic device towards another electronic device, wherein the generated sequence number offset value is for use by the other electronic device in generating a sequence number for a subsequent transmission.

29. The electronic device of claim 28, wherein the means for generating comprises a data processor and the means for transmitting comprises a transmitter.

30. The electronic device of claim 28, wherein the electronic device comprises one of a base station or a mobile station, wherein the other electronic device comprises one of a base station, a mobile station or a center node, wherein if one of the electronic device or the other electronic device comprises a mobile station then the other of the electronic device and the other electronic device does not comprise a mobile station.

31. An electronic device comprising:
a receiver configured to receive a protected message comprising a generated sequence number offset value over a wireless communication link from another electronic device; and
a data processor configured to generate a sequence number based on the generated sequence number offset value and another sequence number.

32. The electronic device of claim 31, wherein the electronic device comprises one of a base station, a mobile station or a center node, wherein the other electronic device comprises one of a base station or a mobile station, wherein if one of the electronic device or the other electronic device comprises a mobile station then the other of the electronic device and the other electronic device does not comprise a mobile station.

33. A method comprising:
generating, by a first device, an offset value based on a first function and information common to a second device, wherein the offset value has a non-zero value;
determining, by the first device, a second sequence number based on a first sequence number and the generated offset value; and
one of transmitting or receiving a message towards or from the second device utilizing the determined second sequence number.

34. The method of claim 33, further comprising:
generating, by the second device, the offset value based on a second function and information common to the first device, wherein the offset value has a non-zero value;
determining, by the second device, the second sequence number based on the first sequence number and the generated offset value; and
one of receiving or transmitting the message from or towards the first device.

35. The method of claim 33, wherein the first device and the second device comprise components of an evolved universal terrestrial radio access network (E-UTRAN), wherein the first device comprises one of an E-UTRAN node B (eNB) or a user equipment (UE), wherein the second device comprises one of an eNB, a UE, a serving gateway or an access gateway, wherein if one of the first device or the second device comprises a UE then the other of the first device and the second device does not comprise a UE.
